(19) United States
(12) Patent Application Publication
(10) Pub. No.: US 2007/0133588 A1
(43) Pub. Date: Jun. 14, 2007

(54) Scheduling apparatus and method in channel bonding transmission system

(75) Inventors: Ho-Jin Kwon, Seoul (KR); O-Hyung Kwon, Daejon (KR); Soo-In Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/607,528

(22) Filed: Nov. 30, 2006

(30) Foreign Application Priority Data
Dec. 9, 2005 (KR) 10-2005-0121178
Apr. 19, 2006 (KR) 10-2006-0035470

(51) Int. Cl. H04L 12/28; H04L 12/56

(52) U.S. Cl. 370/431; 370/395.4

(57) ABSTRACT

Provided is a scheduling apparatus and method in a channel bonding transmission system. The apparatus includes: a downstream service identifier storing unit for storing information related to a downstream service identifier (DSID); a packet transmitting unit for transmitting a packet inputted from outside; a packet classifying unit for analyzing the packet and distributing the downstream service identifier; a virtual storing unit for storing the packets by the packet classifying unit; a monitoring unit for checking downstream service identifier information of the packet stored in the virtual storing unit and requesting channel distributing and channel holding; a channel checking unit for checking the status of channels; a scheduling control unit for acquiring channel information from the downstream service identifier storing unit and controlling packet forwarding; a scheduling unit for forwarding the packets; and an output unit for outputting the forwarded packets.

### FIELD OF THE INVENTION

The present invention relates to a scheduling apparatus and method that can efficiently transmit data by channel bonding in conformity to the Data Over Cable Service Interface Specifications (DOCSIS) 3.0 standard for providing an interactive high-speed data service in a cable network.

### DESCRIPTION OF RELATED ART

The Data Over Cable Service Interface Specifications (DOCSIS) standard is established in CableLabs to provide an interactive high-speed data service in a cable network. A current DOCSIS 2.0 standard provides a transmission speed of about 30 Mbps (6.4M, 64 QAM) in upstream transmission and about 42 Mbps (6 MHz, 256 QAM) in downstream transmission. A DOCSIS 3.0 standard for increasing a transmission bandwidth through channel bonding is being developed to provide diverse services and improve a transmission speed. A transmission speed according to the number of the bonded channel is as shown in Tables 1 and 2 below.

FIG. 1 shows a channel bonding transmission system in a general cable network. FIG. 1 shows a Cable Modem Termination System (CMTS) 110, cable modems 120 and multiple channels 130.

The CMTS 110 includes an IP Forwarder, a Service Flow (SF) Classifier and a downstream channel distributor. The CMTS 110 simultaneously transmits the packets about one service with the cable modem 120 by using a plurality of channels. The cable modem 120 receives the packets about the transmitted one service from CMTS on a plurality of channels. Therefore, the transfer rate increases between the CMTS 110 and the cable modem 120 according to the number of the bonded channel. This was shown in the table 1 and table 2.)

However, the states of each channel are different from each other since one CMTS transmits packets with a plurality of CMs. Therefore, it is difficult to expect the increase of transfer rate according to the number of the bonded channel as shown in Tables 1 and 2.)

In the DOCSIS 3.0 standard, a channel bonding process delay time in the CMTS 110 is as a maximum of 5 ms. A scheduling method used in the CMTS 110 should satisfy the DOCSIS 3.0 standard. Thus, it is specified in the DOCSIS 3.0 standard that the time required for processing the channel bonding in the CMTS 110 is the maximum 5 ms. The CMTS requires a suitable scheduling method in order to satisfy the channel bonding processing time described above.

TABLE 1

| The number of | Channel | Channel |
|---|---|---|
| channels bonded | bandwidth = 6 MHz | bandwidth = 8 MHz |
| 1 | 42.884296 | 55.616 |
| 2 | 85.768592 | 111.232 |
| 4 | 171.537184 | 222.464 |
| 8 | 343.074368 | 444.928 |
| 16 | 686.148736 | 889.856 |
| 32 | 1372.297472 | 1779.712 |

TABLE 2

| The number of | Channel | Channel |
|---|---|---|
| channels bonded | bandwidth = 6.4 MHz | bandwidth = 6.4 MHz |
| 1 | 30.72 | 30.72 |
| 2 | 61.44 | 61.44 |
| 4 | 122.88 | 122.88 |
| 8 | 245.76 | 245.76 |
| 16 | 491.52 | 491.52 |
| 32 | 983.04 | 983.04 |

Generally, the scheduling method determines a route and the order of transmission for forwarding the traffic inputted to the node comprising data communications network, on which a multi-path exists, to the destination.) The scheduling method is determined according to the characteristic of a system.

The CMTS 110 in conformity to the DOCSIS 3.0 standard should simultaneously transmit packets on a plurality of channels. Accordingly, when scheduling methods for typical single output, e.g., First Come First Served (FCFS), Priority Queuing (PQ) and Weighted Fair Queuing (WFQ), are used in the CMTS with a plurality of channels, the scheduling method is independently used in each channel. There is a problem that a transmission delay time between packets, which are simultaneously transmitted through a plurality of channels, may increase according to the status of each channel

FIG. 2 shows a scheduling apparatus of each channel in the CMTS with a plurality of output channels as described above.

FIG. 2 shows an inputted packet 210, a CMTS 220, a packet classifier 221, a downstream channel distributor 222, channels 231 to 234 to be transmitted, schedulers 241 to 244, and packets 251 to 254 inputted from the downstream channel distributor 222 to the schedulers 241 to 244.

The packet 210 inputted to the CMTS 220 is distributed to the channels 231 to 234 to be transmitted from the downstream channel distributor 222 through the packet classifier 221. Since the schedulers 241 to 244 of each channel independently perform scheduling on the inputted packets 251 to 254, there are problems that an order of the packets may be changed in transmission and a delay time between the packet transmissions.

### SUMMARY OF THE INVENTION

It is, therefore, an object of the present invention to provide a scheduling apparatus and method in a channel bonding transmission system, in which channel distribution is requested based on a downstream service identifier for scheduling, and channels are distributed or held accordingly.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a scheduling apparatus in a channel bonding transmission system, the apparatus including: a downstream service identifier storing unit for storing information related to a downstream service identifier (DSID); a packet transmitting unit for transmitting a packet inputted from outside; a packet classifying unit for analyzing the packet from the packet transmitting unit and distributing the downstream service identifier based on the downstream service identifier storing unit; a virtual storing unit for storing the packets where the downstream service identifier is distributed by the packet classifying unit according to the downstream service identifier; a monitoring unit for checking downstream service identifier information of the packet stored in the virtual storing unit and requesting channel distributing and channel holding; a channel checking unit for checking the status of channels; a scheduling control unit for acquiring channel information on the downstream service identifier receiving the request of channel distributing and channel holding of the monitoring unit from the downstream service identifier storing unit and controlling packet forwarding based on channel status information acquired from the channel checking unit; a scheduling unit for forwarding the packets stored in the virtual storing unit by control of the scheduling control unit; and an output unit for outputting the forwarded packets.

In accordance with another aspect of the present invention, there is provided a scheduling method in a channel bonding transmission system, the method including the steps of: a) receiving an inputted packet; b) classifying the received packet and distributing a downstream service identifier (DSID); c) storing the packet where the downstream service identifier is distributed according to the downstream service identifier; d) requesting channel distribution for the stored packet; e) checking a channel status and distributing the channel; and f) forwarding the packet through the distributed channel.

### BRIEF DESCRIPTION OF THE DRAWINGS

The above and other objects and features of the present invention will become apparent from the following description of the preferred embodiments given in conjunction with the accompanying drawings, in which:

FIG. 1 shows a general channel bonding transmission system in a cable network;

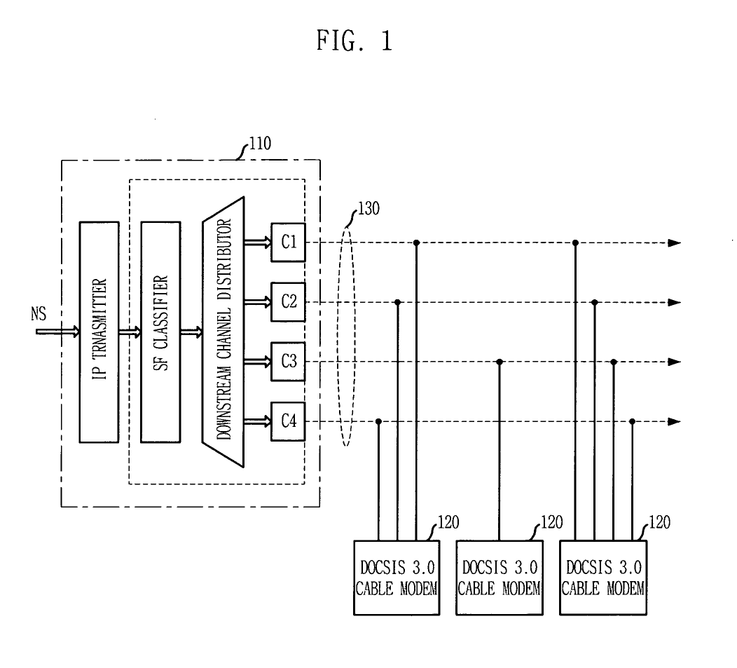

FIG. 2 shows a scheduling apparatus of each channel in a Cable Modem Termination System (CMTS) with a plurality of output channels;

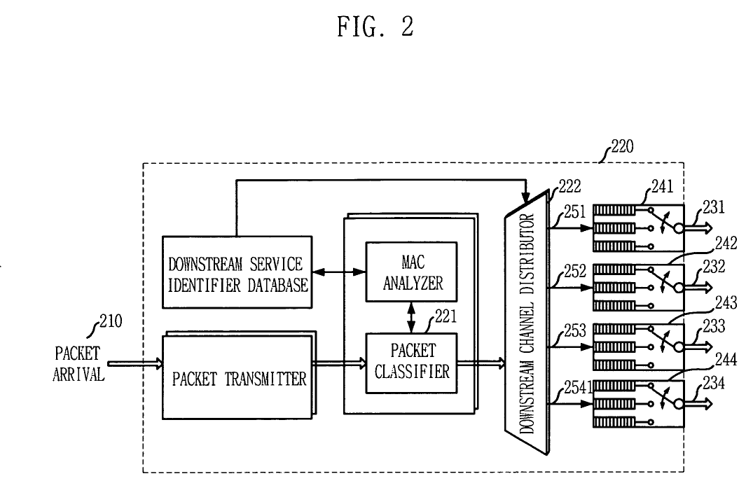

FIG. 3 is a block diagram showing a scheduling apparatus in a channel bonding transmission system in accordance with an embodiment of the present invention;

FIG. 4 is a flowchart describing a scheduling method in the channel bonding transmission system in accordance with an embodiment of the present invention; and

FIG. 5 is a flowchart illustrating a channel distributing procedure in the scheduling method of the channel bonding transmission system in accordance with the embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

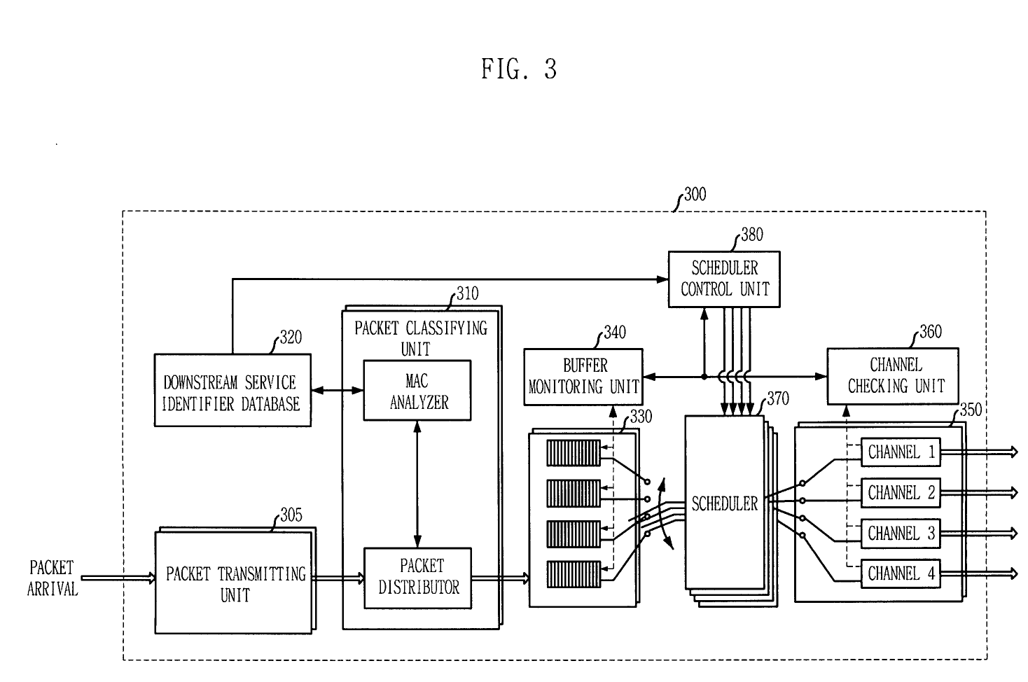

FIG. 3 is a block diagram showing a scheduling apparatus in a channel bonding transmission system in accordance with an embodiment of the present invention. The scheduling apparatus in the channel bonding transmission system of the present invention includes a downstream service identifier database 320, a packet Forwarder unit 305, a packet Distributor unit 310, a virtual buffer 330, a buffer monitoring unit 340, a channel checking unit 360, a scheduler control unit 380 and a channel unit 350.

The downstream service identifier database 320 stores information related to a downstream service identifier (DSID) set up in an initializing procedure between the CMTS and the cable modem. The packet forwarder unit 305 transmits a packet inputted from outside. The packet distributor unit 310 analyzes a destination address and a service kind of the packet inputted from the packet forwarder unit 305 and distributes a downstream service identifier (DSID) based on the downstream service identifier database 320.

The virtual buffer 330 stores packets, to which the downstream service identifier is distributed by the packet distributor unit 310, according to each downstream service identifier in a virtual buffer. The buffer monitoring unit 340 checks downstream service identifier information of the packet stored in the virtual buffer 330 and requests channel distributing and channel holding to a scheduler control unit 380.

The channel checking unit 360 checks the status of the channels and notifies channel status information to the scheduler control unit 380. The scheduler control unit 380 acquires channel information such as bonding information and service class information on the downstream service identifier, which receives the request of channel distributing and channel holding from the buffer monitoring unit 340, from the downstream service identifier database 320, and controls the scheduler 370 to forward the packet stored in the virtual buffer 330 based on the channel status information acquired from the channel checking unit 360.

The scheduler 370 forwards the packets stored in the virtual buffer 330 to the 350 by control of the scheduler control unit 380. The channel unit 350 outputs the packets forwarded by the scheduler 370. The scheduling apparatus in the channel bonding transmission system of the present invention uses a scheduling method based on the downstream service identifier.

The downstream service identifier is set up in the initializing procedure between the CMTS and the cable modem. It has information on the channel bonding, the number of the bonding channel and the service class. Also, all service flows have the downstream service identifier in the DOCSIS 3.0. Accordingly, when scheduling is performed based on the downstream service identifier in the channel bonding transmission system, it is possible to provide differentiated services and channel bonding transmission.

Also, efficient channel bonding is possible not by storing the packet in an output channel and independently performing scheduling on the packet, but by storing the packet in the step of distributing the channel and performing scheduling on the packet according to the channel status.

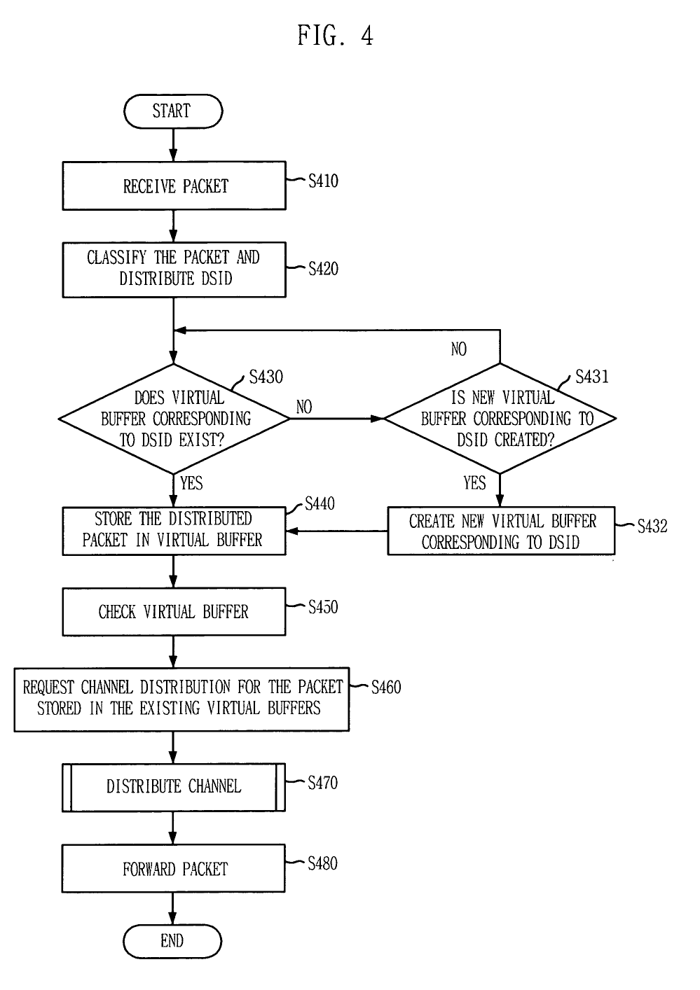

FIG. 4 is a flowchart describing a scheduling method in the channel bonding transmission system in accordance with an embodiment of the present invention.

The channel bonding transmission system receives an inputted packet at step S410, classifies the received packet and distributes the downstream service identifier at step S420.

The downstream service identifier stores the distributed packet in the virtual buffer according to the downstream service identifier at step S430, S431, S432 and S440. The downstream service identifier checks downstream service identifier information of the packet stored in the virtual buffer at step S450 and requests channel distribution of the packet stored in the existing virtual buffers at step S460.

Subsequently, the channel bonding transmission system checks the channel status and distributes the channel at step S470. The packet is forwarded through distributed channel at step S480.

Meanwhile, the procedures of S430, S431, S432, and S440 describe a process of storing the packet distributed by the downstream service identifier in the virtual buffer according to the downstream service identifier. According to the process, at step S430, it is checked whether the virtual buffer for the distributed downstream service identifier exists. At step S440, the packet in the corresponding virtual buffer is stored when the virtual buffer corresponding to the distributed downstream service identifier exists. A new virtual buffer is created for the downstream service identifier at steps S431 and S432. At step S440, the packet is stored when the virtual buffer corresponding to the distributed downstream service identifier does not exist. When the new virtual buffer for the downstream service identifier is not created at step S431, the logic flow goes to the step S430.

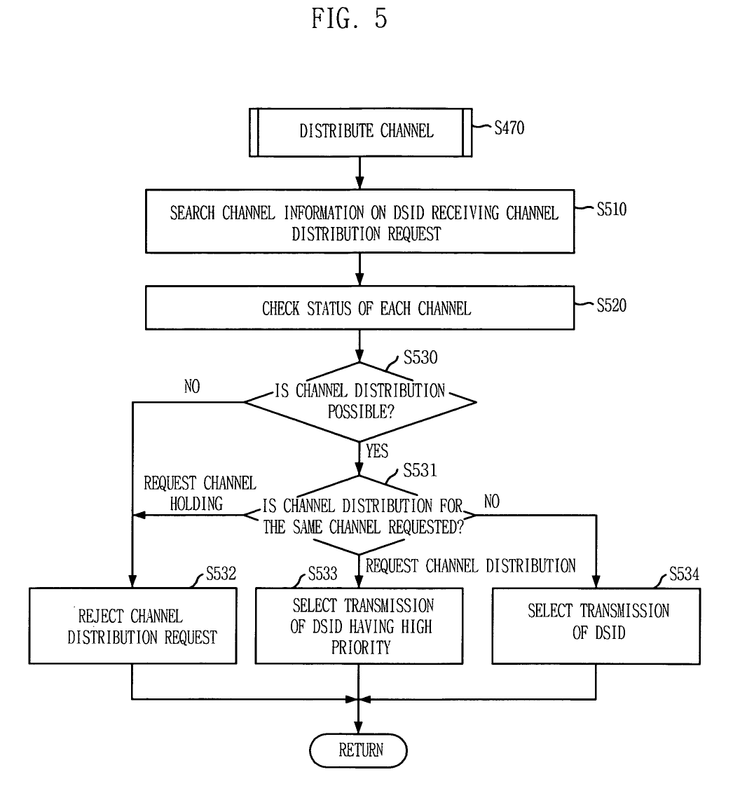

FIG. 5 is a flowchart illustrating a channel distributing procedure in the scheduling method of the channel bonding transmission system in accordance with the embodiment of the present invention. The channel bonding transmission system searches channel information such as bonding information and service class information on the downstream service identifier receiving the request of the channel distribution at step S510, checks status of each channel at step S520 and checks whether channel distribution is possible at step S530.

When it turns out that the channel distribution is not possible at step S530, channel distribution request is rejected at step S532. When it turns out that the channel distribution is possible, it is determined whether channel distribution for the same channel is requested at step S531.

When it turns out that the channel distribution for the same channel is requested, transmission of downstream service identifier having a high priority is selected at step S533. The channel distribution is rejected with respect to the channel holding request for the same channel at step S532. When there is no request for the channel distribution with respect to the same channel, transmission of the downstream service identifier is selected at step S534.

In a scheduling method, the present invention can efficiently perform channel bonding transmission since the present invention distributes the channel according to the channel status not by independently performing scheduling in each channel with respect to the packets to be transmitted to the same cable modem, but storing the packet in the buffer of the packet classifying unit and periodically requesting channel distributing and channel holding.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent applications No. 2005-0121178 and No. 2006-0035470 filed with the Korean Intellectual Property Office on Dec. 9, 2005, and Apr. 19, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A scheduling apparatus in a channel bonding transmission system, comprising:
a downstream service identifier storing means for storing information related to a downstream service identifier (DSID);
a packet transmitting means for transmitting a packet inputted from outside;
a packet classifying means for analyzing the packet from the packet transmitting means and distributing the downstream service identifier based on the downstream service identifier storing means;
a virtual storing means for storing the packets where the downstream service identifier is distributed by the packet classifying means according to the downstream service identifier;
a monitoring means for checking downstream service identifier information of the packet stored in the virtual storing means and requesting channel distributing and channel holding;
a channel checking means for checking the status of channels;
a scheduling control means for acquiring channel information on the downstream service identifier which receives the request for channel distribution or channel holding from the monitoring means from the downstream service identifier storing means, and controlling packet forwarding based on channel status information acquired from the channel checking means;
a scheduling means for forwarding the packets stored in the virtual storing means under control of the scheduling control means; and
an output means for outputting the forwarded packets.

2. The scheduling apparatus as recited in claim 1, wherein the downstream service identifier is set up in an initialization procedure between a CMTS and a cable modem, and includes bonding information including information on channel bonding and the number of bonded channels, and service class information, the bonding information.

3. A scheduling method in a channel bonding transmission system, comprising the steps of:
a) receiving an inputted packet;
b) sorting the received packet and distributing a downstream service identifier (DSID);
c) storing the packet with the downstream service identifier distributed thereto according to the downstream service identifier;
d) requesting channel distribution for the stored packet;
e) checking a channel status and distributing the channel; and
f) forwarding the packet through the distributed channel.

4. The method as recited in claim 3, wherein the step c) includes the steps of:
c1) checking whether a virtual buffer corresponding to the distributed downstream service identifier exists;
c2) when the virtual buffer corresponding to the distributed downstream service identifier exists, storing the packet in the virtual buffer; and
c3) when the virtual buffer corresponding to the distributed downstream service identifier does not exist, creating a new virtual buffer corresponding to the downstream service identifier and storing the packet.

5. The method as recited in claim 3, wherein the step b) includes the steps of:
b1) searching channel information on the downstream service identifiers requested for channel distribution, checking the status of each channel and checking whether the channel distribution is possible;
b2) when the channel distribution is not possible, the channel distribution request is rejected;
b3) when the channel distribution is possible, checking whether channel distribution for the same channel is requested;
b4) when channel distribution for the same channel is requested, selecting transmission of a downstream service identifier having a high priority and rejecting channel distribution with respect to the channel holding request for the same channel; and
b5) when channel distribution for the same channel is not requested, selecting transmission of the downstream service identifier.
